(19) United States
(12) Patent Application Publication
(10) Pub. No.: US 2008/0313115 A1
(43) Pub. Date: Dec. 18, 2008

(54) Behavioral Profiling Using a Behavioral WEB Graph and Use of the Behavioral WEB Graph in Prediction

(76) Inventor: Brian Galvin, Seabeck, WA (US)

Correspondence Address: CENTRAL COAST PATENT AGENCY, INC, 3 HANGAR WAY SUITE D, WATSONVILLE, CA, 95076, US

(21) Appl. No.: 11/951,855

(22) Filed: Dec. 6, 2007

Related U.S. Application Data
(60) Provisional application No. 60/943,478, filed on Jun. 12, 2007.

(51) Int. Cl. G06F 17/00

(52) U.S. Cl. 706/21

(57) ABSTRACT

A method for predicting demographic phenomena has steps for (a) determining behavioral characteristics of a specific population group related by one or more of interest or behavior; (b) creating one or more browsing software agents incorporating behavioral characteristics from step (a) and enabled to browse a network graph; (c) executing the software agents against the network graph, and noting resulting network phenomena; (d) monitoring the network graph in absence of execution of the software agents; and (e) in the event of reappearance of phenomena from step (c), concluding that real persons of the specific population group are active in producing the network phenomena.

### CROSS-REFERENCE TO RELATED APPLICATIONS

The present application claims priority to provisional patent application 60/943,478, filed Jun. 12, 2007, and the prior application is incorporated in its entirety at least by reference.

### BACKGROUND OF THE INVENTION

1. Field of the Invention

This invention is in the broad field of information technology, and pertains more particularly to searching in data collections, particularly collections stored and related in networks such as the World Wide Web, and to ranking results returned from search queries executed against those collections.

2. Description of Related Art

As information proliferates at an ever-increasing pace, one of the greatest areas of need in information technology is in the area of ways to find needed information, as described briefly above, and this is an area served in one important aspect by search engines and associated systems that enable users to find information, such as in web pages in the Internet network. Search systems and search engines are a particular focus in embodiments of the present invention.

A goal of most search engines is to make it possible for users to easily find and/or access relevant data on the world wide web (WWW). Relevance is always of great importance, and is perhaps best judged by the person looking for the information.

A key subsystem of most known search engines is a system for crawling the Web and collecting information, known in the art as a Web crawler. Without regularly crawling the Web to update the information there available, a search engine will rapidly become outdated and irrelevant. Further the Web crawling subsystems are needed to be efficient and to operate on a relatively large scale. Ideally such search engines should operate without disrupting the Web itself or the sites (pages) that are crawled. Many innovations in this area are sought, including methods for checking pages for updates including soliciting involvement from content owners in notifying the search engine enterprises of relevant changes, methods for caching data and parallelizing the process of crawling, and more. Typically the result of the Web crawling is a database of Web content that may span more than 10 billion Web pages, all or part of the content of which may be collected and archived by the search engine.

Pages collected by a crawler subsystem are analyzed in a variety of ways well known in the art to create an index of page identifiers and links to the pages. Such a search index serves much the same purpose as the index of a book; for any term or terms entered as search criteria, a list of pages, with links to those pages, is returned. More broadly, a goal of the Web search index is to return a list of pages when a user enters a search query such as, for example, “dramatic innovations”. Typically pages returned are pages in which the terms are simply present, although it might be preferable to also return pages that may not contain the search terms, but may nevertheless be relevant to the needs of the person who enters the search query. For instance, in response to a search query stated as “dramatic innovations”, the search engine might return links to the history of the Wright Brothers' airplane innovation, even though the history may not comprise the specific term. Relevance is of great importance. A Web crawler is a means to an end in search. An index built from information garnered by a crawler is one of the core elements of a search system.

An index, however, is of little use unless users can use it to search the Web, so a user interface is needed. In such an interface, typically operated from an application known in the art as a browser, the user enters a search query and typically presses Enter. The query is sent, via the Internet network, to the enterprise hosting the search service, of which several major enterprises are well-known. The search engine then uses the present index (the index may change over time as Web crawling progresses) to make a list of Web pages that match the search query. Again, a key challenge is to provide that the most relevant results for this particular user are displayed at or near the top of the list.

The known need for relevance has been a very important motivator in developing a page ranking algorithm. A page ranking algorithm (or node ranking algorithm) is a ranking subsystem, which determines the order of display of the search results. The criticality of this function is that a person searching is going to look at the top-listed pages, rather than digging down to buried information, especially if it is clear that there is a ranking system meant to present more relevant pages nearer the top. Additionally, if the relevance determinations are considered authoritative by many users, the tendency to only look at highly-ranked search results becomes more pronounced, making the impact of the relevance scores very large.

One of the most effective page ranking algorithms in the art at the time of filing the present application is the PageRank algorithm of Google™, Incorporated. The effectiveness of the PageRank algorithm is related in the current art, at least in part, to a structural graph and a matrix computation. The structural graph is a representation of the structure of linkages between pages in the form of a “graph”, as is well known in the art of graph theory. It is well known that, although there are additions and variations, the PageRank system basically works by giving indexed pages a score that is calculated by adding up the number of links that point to the page to be ranked from other pages, and weighting this score based on similar scores calculated for the linking pages. That is, if there are five pages that link to a page to be ranked, but no other page links to the five pages, then the PageRank for that page will be much lower than for a page that has five in-links that each come from highly ranked linking pages (these in turn are highly ranked because many pages link to them, and so on). It is clear that the calculation for page ranking involves relatively complex mathematics, since the score of one page is determined by the scores of linking pages, whose scores are in turn determined by the scores of their linking pages, whose scores are determined by the scores of their linking pages, and so on at least to some pre-determined depth.

From this description it becomes clear why a graph is needed—in current art it is necessary to understand the structure of linkages that connect Web pages in order to perform the calculation, which is based on these links.

In a somewhat abstract sense one may visualize the WWW as a vast array of dots (points, or nodes), each of which represents a Web page connected in the Internet network. To represent nearly all of the existing pages at any one point in time would need perhaps 10¹⁰ points. Each of the pages is, of course, a collection of code, typically in HTML format (or one of its well-known extensions such as DHTML, Cascading Style Sheets, etc.), that defines page content, which may be presented by the page through a user's computer typically using a web browser, which may include text, graphics, audible music and voice, video, and more. Another component of almost any page in the Web is at least one link for initiating a transfer to a different page, or in some cases more recently, initiating a transfer of code and data to a user's computer for some purpose, without requiring transition to a different page. FIG. 1 is a very simple illustration of the one-dot-for-a-page illustration or view of the WWW introduced above. Only five page-representative dots are shown, as sufficient for the purpose, these being pages 101 through 105. A link for the present purpose may be considered the well-known navigational element in the display of a web page for which the cursor typically turns into a hand with a mouseover, and for which clicking-on asserts an address (such as a Universal resource locator URL), which takes the user to another Web page. The link area in a display can be an icon, text, or even an animated figure.

In FIG. 1 the links are shown as arrows. Note that page 105 has links to all of pages 101 through 104, none of which link back to page 105. Links 101 through 104 each have one link to another one of the pages. It is helpful to consider that, although a link is a link, there is a difference in links from the view of the page itself. From the viewpoint of the page, a link may be an out-link (an outgoing link to another page) or an in-link to the instant page from another page. Consider, for example, page 103, which has two in-links, one each from pages 102 and 105, and one out-link to page 104. Consider also that not all links to or from these five pages may be shown, because a very limited subset of pages is illustrated. Page 105, for example, may have several in-links from pages not shown. For the purpose of a state-of-the-art page ranking system, it is the in-links that are typically most important.

In the current art, according to all of the information known to the inventor, the PageRank algorithm and all other search ranking systems are based on the static link structure of the World Wide Web, as briefly described above. The random page graph shown, with the links shown, however, is not a good mathematical model for the purpose. For better computation efficiency a better model (graph) is shown in FIG. 2. The inventor terms this graph a Structural Web Graph (SWG). It should be understood as well, at the outset, that a SWG may only ever show a subset of the WWW structure, and the size and structure of the WWW is in constant flux. In this SWG concept each Web page in the WWW (or a subset) is still a point, but the pages are not illustrated in random space, but in rows and columns. So in the SWG of FIG. 2 there are five rows, each identified by the page association, and also five columns, each also identified by the same page association. By using the same five pages as in FIG. 1, a six-by-six matrix results, considering the five pages and the necessity of having an origin to the matrix. If the matrix were defined for essentially all Web pages, it would be as big as 10¹⁰ rows and 10¹⁰ columns.

In FIG. 2 the rows and columns are shown with identifiers for the pages associated with each row and column. In a workable, mathematical definition to be machine-manipulated, the rows and columns would simply be identified in a data convention; the matrix might never be displayed.

The matrix as shown in FIG. 2 creates a row-column intersection for each page represented with every other page represented in the matrix. This is a basis of its utility. There is also an intersection for each page with itself, which has no utility for the present purpose, and these intersections have been marked in FIG. 2 by an X.

Now consider, as an example of the utility of the SWG, which is well-known in the art, the following illustration. The intersection of the row for page 104 with the column for page 102, which is labeled in FIG. 2 as element 201, presents an opportunity to represent a particular relationship between pages 104 and 102, which may be shown in a number of ways, one of which is simply a value placed at the intersection. In this case the value, by convention, is to represent whether there is an in-link from 102 to 104. Since there is not, the value is zero.

It should be recognized that at an intersection the convention of labeling the intersection with a value based on the existence of a link from the page represented by the column to the page represented by the row is arbitrary; one could as easily have chosen a convention of in which the element 201 would represent a link from page 104 to page 102, and would thus still be set to zero (since the path from 102 to page 104 is indirect; there is no link from 102 to 104 in FIG. 1). A primary function of the SWG utilized in most search engines in the art is to capture the plurality of link relationships between pages in a computationally useful way. In-links are the most useful, since they represent the choices of web page designers to link from the pages they are designing to other web pages. It will be appreciated that pages that are heavily linked to are likely to be more relevant, whereas pages with many out-links may or may not be relevant (the designers of these pages being free to add more out-links, since they control the content of their own pages, they would be able to easily inflate the relevance scores of their pages). A web crawler may garner this information by crawling each web page and noting the links from that page to other pages; in the case of element 201 of FIG. 2, the crawler when reaching page 104 would have noted no link to page 102 and thus marked a zero in element 201, as shown in FIG. 2.

Crawling FIG. 1 provides information that page 104 is linked (has in in-link) from page 103, but not from page 102. Therefore the value at 201 is zero, but the value at the intersection of the row for 104 and the column for page 103 is 1. By the same process, crawling FIG. 1 the values at all of the other intersections are determined, and have been indicated in FIG. 2.

In this particular example, the values are one or zero, which may be convenient for computer simulation and manipulation. Of course other values may be assigned, and in the real world values may be weighted by a number of other considerations, not just whether there is an in-link from the secondary to the primary page. For example, it is common in the art to normalize the values of the Structural Web Graph so that the sum of all of the values in the Structural Web Graph is equal to one, making each value equal to a probability that a random web surfer might make a particular transition from one page to the next (and, continuing this convention, the sum of the values of a column represent the probability that a random web surfer will, after a long session, find herself on the page represented by the column).

A page ranking algorithm, which may take many forms, might, in a primitive form, just consider the SWG once to rank a page. The value at each intersection may be one or zero, but there is a possibility of a 1 for a primary page at each intersection for another page. For page 104 the sum of values at intersections across the row is two. So page 104 may be given a rank value of two, since two pages (103 and 105) link into page 104. The rank value for page 105 would be the sum for the row for page 105, or zero, since no pages link in to page 105. In FIG. 2 the sum for every row but 105 is two, so the pages other than 105 may have equal rank, or there may be a tie-breaker in the algorithm. In a real-world case there are many, many more intersections to consider, and one page may be seen to be linked to from dozens or hundreds of other pages.

In a more sophisticated situation, the page ranking algorithm may first consider the row sum for a page, and then look at the in-links for each of the secondary pages at the positive intersections; that is, an answer to the question: How many pages link in to each page that links directly to the page being ranked, which may be extended to how many (and which ones) link to each page that links to the instant page. Now the value for ranking becomes more realistic and granular, but is still limited to the structural links designed into the pages of the Web. This approach is the basis of the well-known PageRank algorithm pioneered by Google™; the heuristic that drove this step was that links represented authorities, and the relative in-link density of a given authority provides a good indication of the importance of that authority. So at least a nominal relevancy was indicated.

In summary, a search engine in the present art comprises a few key elements, such as a Web crawler to discover and gather information about Web pages, an index of Web pages composed of information garnered by the crawler, a search function that determines which of the pages in the index to present to a viewer, based at least in part on the search query entered by the browsing person, a Structural Web Graph based also on the information retrieved by the crawler, and a PageRank algorithm that uses the Structural Web Graph and values assigned in the graph to give each page a unique PageRank score, for ordering the displayed return of the pages. U.S. Pat. No. 6,285,999 issued to Lawrence Page describes and claims such a PageRank system. U.S. Pat. No. 6,285,999 is incorporated by reference in the present application.

In the current art, in all search systems for the WWW known to the inventor, page ranking is done based on existence of links that are placed in Web pages by the designers of those pages, yet the motivation is relevancy to the users or viewers of the page. Perhaps this known technique provides relevancy to some degree, but what is really needed is a way of measuring the nature of the Web as traversed by real human beings, rather than the structure of the Web as designed by Web page designers, since it is the users who need relevant search results, not the designers. The relationship to behavior of real persons provides for uses that are not possible with static graphs.

### BRIEF SUMMARY OF THE INVENTION

It has occurred to the inventor that a knowledge of usage patterns in search and communication, and the likelihood of patterns being followed or otherwise utilized is very valuable, but this knowledge is not easy to develop or use. Accordingly, the inventor has considered how patterns and probabilities occurring in networked systems might be established and exploited.

The inventor has developed ways to understand and represent probabilities in networks and has considered uses of such organized knowledge; and in one embodiment of the invention has developed a behavioral graph representing probabilities of communication in a network. In developing the behavioral graph the inventor has introduced use of behavioral software agents for mimicking behavior of real persons using the network. Use of such agents provides for many heretofore improbable results, such as predicting terrorist activity and an ability to target advertising.

In one embodiment of the invention a method for predicting demographic phenomena is provided, comprising steps of (a) determining behavioral characteristics of a specific population group related by one or more of interest or behavior; (b) creating one or more browsing software agents incorporating behavioral characteristics from step (a) and enabled to browse a network graph; (c) executing the software agents against the network graph, and noting resulting network phenomena; (d) monitoring the network graph in absence of execution of the software agents; and (e) in the event of reappearance of phenomena from step (c), concluding that real persons of the specific population group are active in producing the network phenomena.

In another aspect a system for predicting demographic phenomena is provided, comprising one or more browsing software agents incorporating behavioral characteristics of a specific population group related by one or more of interest or behavior, a network graph having points associating two network nodes or groups of network nodes, and a computerized mechanism for monitoring changes in the network graph. In this system the browsing software agents are executed against the network graph, resulting phenomena are noted, the network is monitored in absence of the browsing agents, and reappearance of the same or similar phenomena indicates real persons with characteristics of the software agents are active in the network.

### BRIEF DESCRIPTION OF THE SEVERAL VIEWS OF THE DRAWINGS

FIG. 1 is a simple representation of page nodes in an Internet network.

FIG. 2 is an illustration of a Structural Web Graph.

FIG. 3 is an illustration of a Behavioral Web Graph in an embodiment of the invention.

### DETAILED DESCRIPTION OF THE INVENTION

The present inventor believes the nature of a Structural Web Graph, based on links that are inserted in Web pages by the designers of those pages, is a severe limitation to advances in search and ranking of Web pages for relevancy. The fact that the main players in commercial search continue to use a Structural Graph is perhaps understandable, because such a graph is relatively easy to determine by Web crawlers that may search for links in pages. The source code of most Web pages has code that is at least similar to the following example:

<a href=“http://www.patentlyo.com/patent/files/MichelLetter.pdf”>Michel (Chief Judge) Letter.pdf</a>.

This is HTML code for a static link (in this case, to a pdf file). By following such links to Web pages, and then parsing the pages to discover the links each in turn contains, Web crawlers can build a database of links that provides the characteristics of a Structural Web Graph.

Important in the concept of page ranking as used at the time of the present application is the notion that links are a good proxy for understanding which sites are authoritative. This was known and applied in the early days of search technology, and has been extended by the idea that not all links are equal, that a page linked to a page linked to other pages, linked to yet other pages is more authoritative than a page in which the depth of linking through other pages is less. This has been extended such that each link's contribution to a page's rank should be weighted by the ranking of the page that contained the link. Much work has been done to extend page ranking by altering how these weights are determined and applied, but the basic idea has remained essentially unchallenged, and continues to be limited by the use of a Structural Web Graph.

In the inventor's view the Structural Web Graph does not really indicate relevance to any great degree. Ideally, perhaps, relevance might better be measured by asking each search engine user, after that user reviews all the pages returned, which pages the user finds most relevant. This is clearly not practical, for even if most users could be queried, they would never have an opportunity to review all of the pages available to rank in a typical search. So the question becomes: what useful proxy measurements might get close to measuring real relevance, or at least do a noticeably better job than is typically provided using a Structural Web Graph?

Another problem with search systems that use a Structural Web Graph is that many spammers and others who want to artificially influence Web traffic patterns for their own purposes can spoof PageRank by building what are known in the art as link farms, and by otherwise “gaming the system”. This drawback has indeed led to an arms race between spammers and search engine vendors, since the basic idea of the Structural Web Graph-based search engine has been widely known for over ten years. But perhaps the most important shortcoming of the conventional search approach is that the links that are used to build the Structural Web Graphs used by the major search engines do not in fact account for most of the page transitions that actually occur on the WWW. To understand why, consider how one traverses the Web. Generally, a person will use a search engine as a starting point when looking for something that person may not have searched before. The search engine will generate a results page that contains a long list of links to the returned pages—none of which links are in the Structural Web Graph (if they were, then everyone would find the major search engines at the top of every search query results list!). But a person may also use bookmarks (or, if you are avant garde, you might use someone else's bookmarks on del.ici.ous.com, or somewhere else). These bookmarks are not static links that can be traversed by search engine Web crawlers, because they are stored on the browsing person's computer, not on a Website. The same is true of Back and Forward buttons, and of a Web History bar. And, if you read many modern documents such as Word documents and emails, such documents may well include links to Web pages. None of these links are included in a Structural Web Graph either.

In fact, although no one may know for sure, it is likely that only a small portion of Web page transitions that actually occur are the result of a person having clicked on a static link in a Web page. If this is so, then how representative and relevant can the Structural Web Graph built from these links possibly be? Surely a PageRank algorithm is an improvement over simple link counting, but again, is this the best we can do?

In the inventor's opinion one thing that is needed is a system adapted to measure and track movements through the WWW as actually traversed by real human beings, or as potentially traversed by real human beings, rather than the structure of the Web as designed by Web page designers. What is critically needed is termed by the present inventor a Behavioral Web Graph, which may be referred to below as a BWG. A Behavioral Web Graph, unique to the present invention, may be represented in the same square matrix as described above for the Structural Web Graph, except values assigned at intersections for primary pages do not represent the presence or absence of static links, but represent a probability that a browsing person will transition from one page to the other page represented at the intersection, depending on the convention adopted (row-to-column, or vice versa). In the Behavioral Web Graph it doesn't really matter how a person gets from page A to page B; at least a part of the value at (A, B) in the Behavioral Web Graph represents the probability that a surfer on page A will transition from there to page B.

At first blush it might seem that to build a Behavioral Web Graph one would have to track the behavior of a very large number of users of the WWW, which is a truly daunting task. Because of the difficulty of obtaining a relatively complete Behavioral Web Graph, which the inventor defines operationally as the matrix of transitional probabilities from any one Web page to any another that would be obtained if one were able to observe all Web behaviors worldwide for, say, a one month period, no one known to the inventor has ever attempted such a project. However, the present inventor has developed a way to build such a graph in an efficient way.

In an embodiment of the present invention a Behavioral Web Graph may be built by using at least a form of a Structural Web Graph in a unique way. Firstly it is needed to observe and make a record of browsing behavior of a relatively large sample of people ideally (but not necessarily) of various demographics. From the records of observed behavior, people then may be grouped who browse similarly. Various ratios may be helpful, such as a static link usage ratio, a depth of browsing ratio, which is a ratio of average time browsing per domain divided by the total browsing time, a search engine utilization ratio, which is a ratio of transitions made directly from a search results page, and so forth. Also, interest vectors for users and groups of users can be created by referring to the content of pages represented in the Structural Web Graph. An interest vector is a vector in which each element consists of the total of all visits by a population to pages that are correlated with a given interest (based on the analysis of page content that is typically conducted in the indexing function of a search engine); a 200 element interest vector would tally all of the web page accesses by the target population for each of 200 distinct interest categories. One may also measure the most common start points and end points for Web browsing sessions across the measured population.

Given this large, but far from complete data set, one may then start building the Behavioral Web Graph by building an n by n square matrix, where n is the X dimension of the corresponding Structural Web Graph (and the Y dimension as well, since the Structural Web Graph is by definition a square matrix), and populating the new matrix with all zeros. Then, working through the population of observed people, for each observed transition from a page A in the Structural Web Graph to a page B at an intersection in the Structural Web Graph, the value at the intersection (A, B) in the Behavioral Web Graph may be incremented by one. It will be appreciated by the skilled artisan that there are several ways to develop this summing of all of the observed transitions. It will readily be seen, though, that even if the complete browsing behaviors of as many as five million people, for example, were entered into a 10 billion by 10 billion square matrix, the matrix would still be nearly empty. It will also be appreciated that, there being many techniques known in the art for dealing efficiently with very large and very sparse arrays or matrices, it is not necessary to store all of the zeros directly; the description given here is illustrative but does not limit the scope of the invention to the particular method illustrated.

Now, to further the development of the Behavioral Web Graph, a large number of software agents may be created representing (and mimicking) the behavior of typical browsing persons from a weighted distribution of each of analyzed common browsing behavior groups previously created, wherein the weights may be determined by the relative size of each of the common browsing behavior groups. Each software agent type may encode the typical browsing behavior of the common browsing behavior group it is created to represent. This may be done by mimicking the various measured ratios and postulating a typical statistical distribution of interest categories for that common browsing behavior group. When these software agents are built (and more could be built constantly as new behavior patterns are identified), these agents can then be run against the Structural Web Graph, and their browsing behavior tracked. That is, a software simulation agent can proceed by randomly selecting a starting page from all of the possible starting pages, each such page having a probability of being selected equal to the (0,n) probability (using the “column to row” approach, (0,n) gives the probability that a user outside the set of known pages next navigates to page n). Then, each subsequent navigation step can be determined by the statistical model assigned to the simulation agent, based on the observed behaviors of the sample of actual users that was used to build the statistical model of the software simulation agent. There may be a large number of clones of each agent representing a different behavior group, enabling the system to “browse” in parallel to develop additional data more rapidly. It should be understood that the objective of this step is NOT to simply repeat samples of captured behavior for given demographics. The key is to capture, via statistical modeling of observed behaviors of the measured populations, the psychology active in the minds of typical individuals having a particular demographic combination by tuning the software agent's state machine and decision logic such that its resulting browsing sequence will closely match the browsing sequence of the demographic on average. Furthermore, once the agent is tuned (trained), it can be “let loose” on new categories of websites. This means that the agent training process does not need to be continuous and does not have to have comprehensive coverage of the Web.

In addition, it is not necessary that the software browsing agents operate on a single computer. Agents, once created, may be cloned, or may replicate themselves, and may be distributed to and operate on a large number of Internet-connected appliances. In one aspect of the invention individuals might be recruited, either as volunteers or for some agreed-to compensation, to lend their appliances (and themselves) to the creation of data to formulate one or more Behavioral Web Graphs. In one embodiment a program may be installed on a person's computer or other Internet-connected appliance, to track the Web behavior of that person, and to formulate, over a period of time, a software agent to emulate that person's browsing behavior. The behavior profile would not necessarily be a recorded instance of a Web session, but, for example, a program to guide the software agent in browsing by making decisions in browsing that are the same or quite similar to the decisions made by the person whose browsing behavior is the basis of the agent's behavior.

Regardless of where and how such software agents are created and utilized, each software agent may initiate, carry out and terminate millions of sample Web sessions that each follow the probabilistic behavior patterns of the observed common browsing behavior for which the software agent was designed, whether a single person, or a group. As these software agents browse the Structural Web Graph their transitions are added to the working BWG as if they were real transitions of real people. Also, since the software agents can operate against the Structural Web Graph, which acts as a proxy for the actual Web, it is not necessary for the processes that build Behavioral Web Graphs to be continuously connected to the actual Web, and in fact it is perfectly feasible and reasonable to run millions of agents completely isolated from the actual Web—as long as the Structural Web Graph used is a good representation of the Web.

In one embodiment of the invention a conductor, or handler program may coordinate activities of such software agents, much as a supervisor might manage and guide real people in doing a similar task, except the computer simulation process is far faster and more statistically rigorous, and thus develops far more useful data more quickly.

Each software agent may start a browsing session by randomly choosing a starting point (these are identified as those nodes that typically were observed to be starting points, and also potentially pages that are similar in nature to those that were identified as typical starting points). For example, the home pages of commercial Web sites could be common starting points. Alternatively, agents could just start by randomly selecting any row of the Structural Web Graph (or column, if the “column-to-row” orientation is used). Then, by selecting a typical behavior from among the bullet list below, which is a partial list of possible behaviors, by no means complete, the agent would continue to browse until it decided, by its code, to end the session, typically after landing on a typical exit point, again based on patterns observed to occur among real people. For example, a common exit point might be the checkout page of an e-commerce site. Behaviors could include, among many other possibilities:
Following a random out-link from the current page, with the same probability as the observed population;
Ending the session;
Going to a random page that is topically related to the current page;
Going back to the previous page, especially if transitions back and forth between, for example, product viewing and product purchase pages, were observed;
Jumping to a random page that is at least correlated with some interest area for the simulated group. This might, for instance, model a person clicking on a link from their Favorites toolbar;
Transitioning to a search page, where a typical search for the target group would be executed and then pages from the search results could be traversed (note, as sophistication in understanding the groups of related behaviors advanced, one might specify a search query that is commonly seen at this point in a browsing session).

In one embodiment the efficacy of this method may be tested by comparing the actual hit rates, among simulated browsing sessions, of well-known pages, compared to the published traffic levels at those sites. If the simulations are tuned well, and if a sufficiently large population were used to develop the analytical insights upon which the software agent simulations were based, then the relative traffic volumes should be at least somewhat similar.

One may also envision choosing a stopping point in the process when these traffic ratios stabilize and the degree of coverage of the lesser-trafficked Web pages reaches a statistically significant level.

It should be appreciated that, as the amount of traffic that can be observed grows, one may be in a position to build up, through a similar direct sampling and agent-based simulation approach operating on the overall Structural Web Graph, a series of Behavioral Web Graphs, each corresponding to a distinct user demographic. This would be of interest and direct use when, for instance, a major sporting event is known to be upcoming, for determining where best to place ads or where the most likely traffic spikes might occur.

The Behavioral Web Graph in various embodiments differs in some fundamental ways from a Structural Web Graph. For example, as described above, for the Structural Web Graph, given an intersection of a page row and a page column, the value at the intersection indicates a structural link. If such an in-link were to be used, it would have to be initiated in the in-linking page represented by the row number. In the Behavioral Web Graph in one embodiment, the interest is in the probability that a browsing person will move from one page or position in the Web to the other position represented at the intersection. There is no great interest as to whether a link exists from the one page or position in the Web to the other at the intersection. There are other ways to make the transition than exercising a link in a page. One may enter a URL directly, or select from Favorites because the one page reminded him of something, for example. A purpose in the Behavioral Web Graph is to anticipate what people really do.

The value at an intersection in a Behavioral Web Graph in one embodiment, then, is the probability that a browsing person will somehow transition from the position represented as primary in the graph to the position represented as secondary.

Probability in mathematics is often indicated by a decimal number between zero and one, with zero meaning no chance, and one indicating certainty. So in one embodiment, since a user is considered to be at the page or other position represented by the row, if every jump the user might make (including ending the session) is indicated by a column, the probabilities in the row should sum to 1, because all actions that may be taken are represented. In this case a zero row and zero column may be provided in the graph (actually such a row and column could be anywhere in the graph), representing starts and ends of browsing sessions (for example, element (0, 45678) represents the probability that a browser will start the next session at page 45678, and (45678, 0) represents the probability that a user on page 45678 will end their current browsing session from this page. In another embodiment a time element may be included, so the values may represent transition probabilities per unit time. This requires measuring dwell time on each page or position in gathering data for building the Behavioral Web Graph. Additionally, the entire Behavioral Web Graph could be normalized by the same method as outlined in the Page patent referenced above, so that each value represents the likelihood that a random surfer (browsing person) would, after a very long session, find herself on the target page represented by the column after being on the page represented by the row; the total in this case of a column's scores represents the likelihood that the random surfer would, after a long session, be on the page represented by the column, regardless of how she got there.

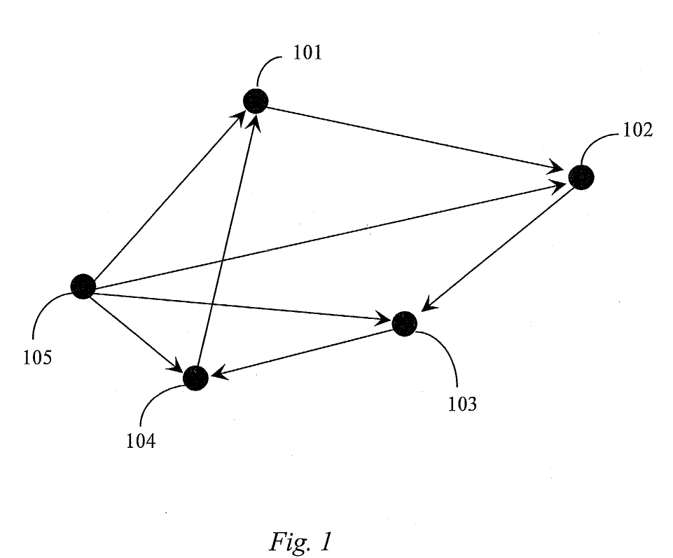

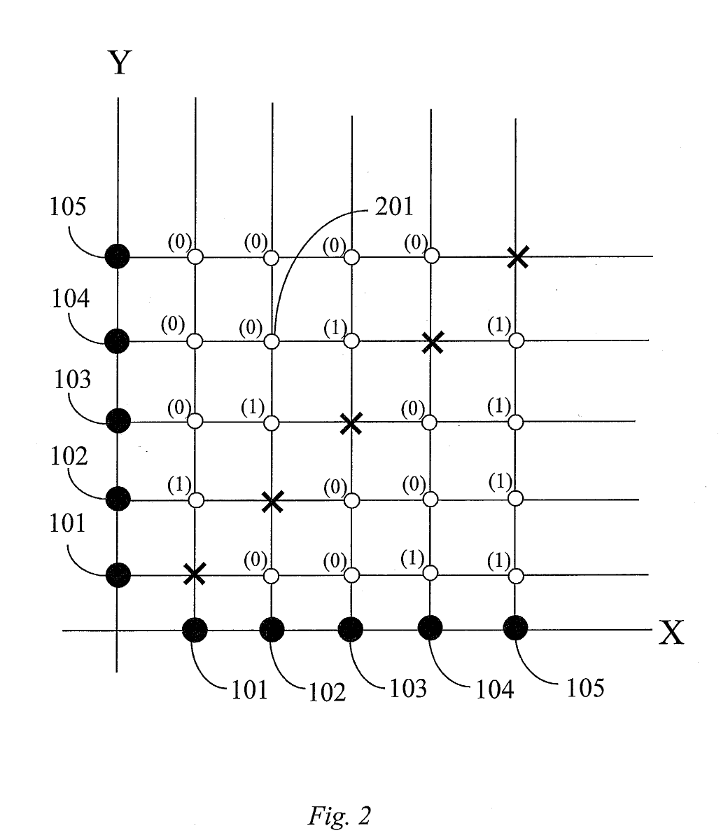

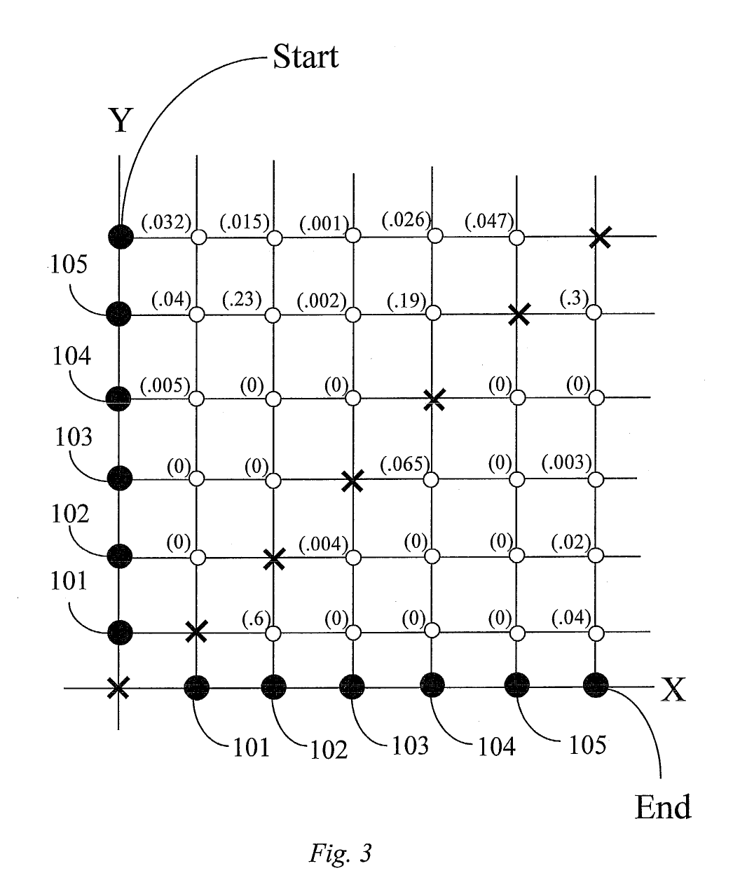

FIG. 3 illustrates a Behavioral Web Graph in one embodiment of the invention, including a row for Start and a column for End. At each intersection the probability that a browsing person will jump from the primary (row) page to the secondary (column) page is indicated, and, for convenience only, the connectivity (links) of FIGS. 1 and 2 is followed as well in FIG. 3. The additional data, that being the probability of a transition, is developed by browsing against the Structural Web Graph of FIG. 2.

The probabilities indicated in the Behavioral Web Graph of FIG. 3 are exemplary only (for example, it should be noted that the probabilities in each row do not add to one because the sample of pages is obviously infinitesimally small compared to the overall Web). As one example, the Behavioral Web Graph of FIG. 3 indicates that a browsing person viewing page 104 has a probability of 0.005 of transitioning to page 101. The graph indicates as well that there is a 0.995 probability that the person viewing page 104 will go somewhere else than page 101, or end the session. As another example, there is a 0.02 probability that the person viewing page 102 will end the session.

It should be appreciated that in embodiments of this invention the role of simulation might diminish as the size of the observed population, and the time of observation, increases. Thus one might proceed iteratively to build a highly simulation-dependent Behavioral Web Graph and to test it against a user population. Then, as data sets grow, and as common browsing behaviors are better understood, the simulation-dependent Behavioral Web Graph may be tuned, and gradually shifted toward a less-simulation-dependent (i.e., directly measured) Behavioral Web Graph.

In another aspect of the invention a Behavioral Web Graph is used with a page ranking algorithm for ranking pages returned in a search. While it will be appreciated that there are many possible algorithms for ranking pages, the following example demonstrates the basic concept and illustrates some advantages of the present invention as compared to systems of ranking that are based on a Structural Web Graph. Consider the well-known PageRank algorithm of the above-referenced Page patent incorporated above (hereinafter Page). It will be seen that the same algorithm can in fact be executed against a Behavioral Web Graph to obtain a ranking vector for each of the web pages represented in the Behavioral Web Graph. Essentially, whereas the linking entries in the Structural Web Graph are used to calculate the PageRank under Page, in the instant invention the same calculational approach is applied against the transition probability entries in the Behavioral Web Graph. As motivation for doing this, consider first the motivation cited by Page for executing his algorithm against the Structural Web Graph (Page did not use this term, but the Structural Web Graph described in this specification does correspond precisely to the approach used by Page). Consider in Page: “Intuitively, a document should be important (regardless of its content) if it is highly cited by other documents. Not all citations, however, are necessarily of equal significance. A citation from an important document is more important than a citation from an unimportant document” (Page, column 2, lines 59-64). Page then goes on to define the recursive PageRank algorithm for taking the importance of each link into account when calculating the rank of each page. In a similar fashion, the motivation for using the PageRank algorithm from Page with the substitution of the Behavioral Web Graph for the Structural Web Graph is that intuitively, a document should be important (regardless of its content) if people access the document from many other pages or positions, especially if the overall probabilities are high. Not all pages or positions from which people may access the document are equal however; accesses from pages that are frequently accessed are more important than accesses from rarely seen pages. Moreover, it is also relevant what percentage of people who have accessed the preceding pages actually choose the document in question as their next web page to view, as opposed to any other document.

Since the transition probabilities in the Behavioral Web Page provide precisely this information (that is, they provide the probability that a person on page m would then transition to page n; if this probability is low, then most people who end up on m do not go on to n). So the use of the PageRank algorithm against the Behavioral Web Graph captures the intuitive heuristic that says that relevance is simply determined by the likelihood that people would actually go to the page, rather than relying on the tendency of web page designers to actually build links to the page. Page uses a readily available data source (the Structural Web Graph, which can be relatively easily built) and a simple heuristic that can be applied using that data source; by contrast, the instant invention in some embodiments uses a much more powerful heuristic that cannot be used unless one has some means to calculate the Behavioral Web Graph. Also, to further highlight the importance of the distinctness of embodiments of the instant invention and its approach, consider this comment in Page: “Because citations, or links, are ways of directing attention, the important documents correspond to those to which the most attention is paid” (Page, column 3, lines 4-6). Because the invention of Page makes use of the links built into web pages to reflect “directing attention”, it is clear that Page takes the point of view of the designers of web sites explicitly (since they are the ones who direct attention); the instant invention instead focuses on how attention is paid, which is often not the same as how it is directed. Accordingly, the instant invention focuses on the point of view of the web user, who pays attention as she will, often and perhaps usually without regard to how the designers of web sites attempt to direct her attention. This is the crucial difference, and much follows from it.

One might readily measure the impact of the Behavioral Web Graph approach by calculating the PageRank vector for the Structural Web Graph and then doing exactly the same calculation for the new Behavioral Web Graph that reflects the actual behavior of real users rather than the link strategies employed by Web site designers. Doing this is measuring, in a sense, the difference between the Web as designed and the Web as used. And the difference is likely to be significant. Just on the basis of providing a superior PageRank result (which the inventor terms the Behavioral PageRank), the value of the instant invention is clear. However, because the Behavioral Web Graph is fundamentally different than the Structural Web Graph, there are many possible applications that simply are not possible using the Structural Web Graph. Because of this dependence on the availability of the novel Behavioral Web Graph, many of these applications are also novel in the art.

In another aspect of the invention implicit correlation of pages may be accomplished. When one has a Behavioral Web Graph available, one can look for clusters of closely related pages as might be indicated by frequent transitions amongst the cluster. Then, if a high-ranking (using the new Behavioral PageRank algorithm) search result for particular search criteria is a member of one of these clusters, other pages that are closely linked to the search result within the cluster might be returned as relevant search results—even though the search terms may not have been contained in the closely linked pages. This is important because these closely linked pages would never have been returned in a typical PageRank search result page and, if one had used static links to create a similar cluster one would likely have generated noise rather than useful results. This may be why search engines have generally stuck to the tried-and-true approach of straightforward index-retrieve-and-rank process. Clusters detected and leveraged in this fashion can be variously strong or weak, open or closed. For instance, a closed cluster may consist of a series of pages that had links between them but no links to any other pages except row/column zero pages. It would be expected that perfectly closed clusters would be very rare (but very interesting), but nearly-closed clusters may be fairly common.

Another difference between the Behavioral Web Graph approach and the Structural Web Graph approach is that, since the Behavioral Web Graph approach is based on user behaviors, it is possible and probably highly desirable to group users by either measured similarities or stated interests or desires (or even better, both ways), and then calculating distinct Behavioral Web Graphs for different segments. It is likely very impractical to maintain many complete graphs (it is a major undertaking to even maintain a single large Structural Web Graph and to calculate PageRank from the graph). However, one could maintain one overall Behavioral Web Graph, and then, for targeted sub-domains have delta graphs which can be applied for particular user populations. For instance, for the subset of pages that are identified as soccer-relevant (based on overall closeness to known soccer-content pages) one could have a delta-graph (a submatrix) for the population of users who have self-identified as soccer fans. This would clearly help in targeting ads, tuning Web sites and anticipating traffic patterns during major matches such as the World Cup.

Many academics have discussed the notion of measuring distance on the Internet, and they have universally done it by measuring how many clicks it takes, on average, to get from A to B using the Structural Web Graph. But in reality the distance should be measured by how many clicks it takes for an average user, behaving in an average way, to get from A to B. This can be obtained directly from the complete Behavioral Web Graph.

One might discern the difference between human browsers and machine browsers by measuring the time between clicks. This would allow distinction between real, human browsers and software agent browsers when building the observed Behavioral Web Graph and calculating the behaviors for building the simulation agents. It also is a reason that the Behavioral Web Graph approach to search will greatly limit the effectiveness of spammers. Link farms will have much less impact since real humans will never traverse them and so they will be underrepresented, systematically, in the Behavioral Web Graph.

In yet another aspect of the invention one can treat search pages as Null Operations, and simply traverse them. So, A-S-B-S-C becomes A-B-C where S means a search page. But one can also treat the set of all search pages as a distinct row/column in the DWG so that one can understand how behavior varies when going to and from search pages. For instance, it would be good to know which kinds of Web pages are almost always reached directly from search pages and hardly ever directly from in-links. In fact, such pages are good examples of the shortcomings of the prior art, since they would be mishandled.

A key distinction is that author does not equal user. The people who build links are authors; the people who browse the Web are users. Using built-in links as the key to estimating relevance of pages for users is a rough heuristic at best.

In another aspect of the invention certain functions associated with behavioral analysis might be used for national security purposes. One may, for example, create one or more software agents with behavior characteristics of a terrorist, a person who might finance terrorists, a person who may be recruiting terrorists, and so on. By running and tracking such agents it might be possible to identify browsing patterns and/or clusters in a static or Behavioral Web Graph that indicate activity by threats to national security, and to predict terrorist activity based on such results.

In the aspect described immediately above, one might provide a method for predicting demographic phenomena, comprising steps of (a) determining behavioral characteristics of a specific population group related by one or more of interest or behavior; (b) creating one or more browsing software agents incorporating behavioral characteristics from step (a) and enabled to browse a network graph; (c) executing the software agents against the network graph, and noting resulting network phenomena; (d) monitoring the network graph in absence of execution of the software agents; and (e) in the event of reappearance of phenomena from step (c), concluding that real persons of the specific population group are active in producing the network phenomena.

In another embodiment a system for predicting demographic phenomena may be provided, comprising one or more browsing software agents incorporating behavioral characteristics of a specific population group related by one or more of interest or behavior, a network graph having points associating two network nodes or groups of network nodes, and a computerized mechanism for monitoring changes in the network graph. In this system the browsing software agents are executed against the network graph, resulting phenomena are noted, the network is monitored in absence of the browsing agents, and reappearance of the same or similar phenomena indicates real persons with characteristics of the software agents are active in the network.

In yet another aspect, the inventor intends the invention to be useful in many other-than-browser search scenarios, such as voice-enabled search from a cell phone. Further the inventor is aware that the WWW and the Internet are examples, but not the only possible examples, for use of the invention. For instance, one might study patterns of traffic within a telecommunications network and build a behavioral connection graph (generalized notion of Behavioral Web Graph) and then use this to find out who the right people are to connect for a certain reason or purpose. Or people's perusing of documents on their computers may be tracked, even offline, and one could build a behavioral content graph. Certain documents would be often accessed, and perhaps in particular patterns.

In another embodiment of the invention, a Behavioral Graph (notably in this case not a Behavioral Web Graph) could be developed for behaviors of cell phone users. In this case one might use an asymmetric Behavioral Graph where, for example, the rows represent geographical locations (for instance, cell zones), and the columns represent phone numbers which might be called (or from which calls might be received). In this case, one could look for correlations in which certain called numbers are preferentially called from certain locations; for instance, subscribers in a downtown area may be much more likely to call information services for information about concert tickets. It will be readily appreciated that this is likely to vary according to time of day as well. Such as time-dependent Behavioral Graph would be very useful in targeting advertising; for instance, by sending advertisements for theatrical presentations when people are approaching downtown districts in the early evening.

There are uses of embodiments of the invention as well in Social Networking where experiments have been done on available data sources. Invariably, these experiments have been static citation or linkage graphs; for instance, the citations among scientific papers, or the references made within patent databases, or even emails. These are relatively easy to measure, but they are very like the Structural Web Graph in that they capture static linkages that may not reflect real utility. For example it is common in scientific and patent circles to provide references that merely augment the case but don't actually get used or get taken seriously. If one were able to measure what is actually read, or paths actually taken, or sequences of actions, or the actual flow of ideas within a network, then we would be able to work from a totally different kind of data set. So a primary use is Web search but the key concept is much broader.

It will be apparent to the skilled artisan that the embodiments and examples described above are not the only embodiments of the invention, and that many alterations and amendments may be made without departing from the spirit and scope of the invention. The invention is therefore limited only by the claims that follow.

I claim:

1. A method for predicting demographic phenomena, comprising steps of:
(a) determining behavioral characteristics of a specific population group related by one or more of interest or behavior;
(b) creating one or more browsing software agents incorporating behavioral characteristics from step (a) and enabled to browse a network graph;
(c) executing the software agents against the network graph, and noting resulting network phenomena;
(d) monitoring the network graph in absence of execution of the software agents; and
(e) in the event of reappearance of phenomena from step (c), concluding that real persons of the specific population group are active in producing the network phenomena.

2. The method of claim 1 wherein the phenomena noted in step (c) are browsing patterns or clusters.

3. The method of claim 1 wherein the particular population group is a group of terrorists, related by one or more of interest or behavior characteristics, and further comprising a step for predicting terrorist activity based on the phenomena noted in step (e).

4. The method of claim 1 wherein the population group is related by transactional behavior, and appearance of phenomena in step (e) is used in a further step for placing advertisements in the network.

5. The method of claim 1 wherein the network is the Internet network.

6. The method of claim 1 wherein the network graph is a behavioral network graph wherein points in the graph associate specific nodes or groups of nodes, and values at the points indicate a probability of a person connected to one node associated with the point transitioning next to the other node associated with the point.

7. The method of claim 1 wherein the network is a communication network wherein nodes represent a communication device associated with a specific user and coupled to the network.

8. A system for predicting demographic phenomena, comprising:
one or more browsing software agents incorporating behavioral characteristics of a specific population group related by one or more of interest or behavior;
a network graph having points associating two network nodes or groups of network nodes; and
a computerized mechanism for monitoring changes in the network graph;
wherein the browsing software agents are executed against the network graph, resulting phenomena are noted, the network is monitored in absence of the browsing agents, and reappearance of the same or similar phenomena indicates real persons with characteristics of the software agents are active in the network.

9. The system of claim 8 wherein the phenomena noted are browsing patterns or clusters.

10. The system of claim 8 wherein the particular population group is a group of terrorists, related by one or more of interest or behavior characteristics, and further comprising a step for predicting terrorist activity based on the phenomena noted.

11. The system of claim 8 wherein the population group is related by transactional behavior, and appearance of phenomena in step (e) is used in a further step for placing advertisements in the network.

12. The system of claim 8 wherein the network is the Internet network.

13. The system of claim 8 wherein the network graph is a behavioral network graph wherein points in the graph associate specific nodes or groups of nodes, and values at the points indicate a probability of a person connected to one node associated with the point transitioning next to the other node associated with the point.

14. The system of claim 8 wherein the network is a communication network wherein nodes represent a communication device associated with a specific user and coupled to the network.
